(19) United States
(12) Patent Application Publication
(10) Pub. No.: US 2023/0264718 A1
(43) Pub. Date: Aug. 24, 2023

(54) METHOD AND APPARATUS FOR PROCESSING SIGNAL OPERATION INFO OF AN INTERSECTION

(71) Applicant: 42DOT INC., Seoul (KR)

(72) Inventors: Gong Bo MOON, Seoul (KR); Jin Hee Choi, Seoul (KR); Soon Ho Yun, Suwon (KR)

(21) Appl. No.: 18/171,688

(22) Filed: Feb. 21, 2023

(30) Foreign Application Priority Data
Feb. 22, 2022 (KR) 10-2022-0022988

(51) Int. Cl. B60W 60/00; G08G 1/052; G08G 1/056; H04W 4/021

(52) U.S. Cl. CPC B60W 60/00272; G08G 1/052; G08G 1/056; H04W 4/021

(57) ABSTRACT

Provided are a method and device for processing signal operation information of an intersection, and the method includes transmitting, to an external device, a driving status information message regarding a vehicle, determining a particular intersection, based on a current location and heading of the vehicle included in the driving status information message, and receiving, from the external device, a signal operation information message regarding the particular intersection, by using a geofencing area.

### CROSS-REFERENCE TO RELATED APPLICATION

This application is based on and claims priority under 35 U.S.C. § 119 to Korean Patent Application No. 10-2022-0022988, filed on Feb. 22, 2022, in the Korean Intellectual Property Office, the disclosure of which is incorporated by reference herein in its entirety.

### BACKGROUND

### 1. Field

The present disclosure relates to a method and device for processing signal operation information of an intersection.

### 2. Description of the Related Art

A vehicle traveling on a road may drive on any one of a plurality of lanes included in the road. The vehicle may frequently change lanes while driving, and a situation in which the number of lanes on the road is changed also frequently occurs.

Along with the merging of information communication technology and the vehicle industry, smartization of vehicles is rapidly progressing. The smartization of vehicles enables the vehicles to evolve from simple mechanical devices to smart cars, and in particular, autonomous driving is attracting attention as a core technology of smart cars. Autonomous driving is a technology that allows a vehicle to reach its destination on its own without a driver manipulating the steering wheel, accelerator pedal, or brake.

Various additional functions related to autonomous driving have been continuously developed, and there is a demand for research into a method of providing a safe autonomous driving environment to a driver or a passenger by controlling a vehicle based on recognition and determination of a driving environment using various types of data.

Recently, in order to more safely control a vehicle, research is needed to accurately obtain intersection information associated with a driving section of a vehicle.

The related art described above is technical information that the inventor(s) of the present disclosure has achieved to derive the present disclosure or has achieved during the derivation of the present disclosure, and thus, it cannot be considered that the related art has been published to the public before the filing of the present disclosure.

### SUMMARY

Provided are methods and apparatuses for tracking an object. Technical objects of the present disclosure are not limited to the foregoing, and other unmentioned objects or advantages of the present disclosure would be understood from the following description and be more clearly understood from the embodiments of the present disclosure. In addition, it would be appreciated that the objects and advantages of the present disclosure may be implemented by means provided in the claims and a combination thereof.

Additional aspects will be set forth in part in the description which follows and, in part, will be apparent from the description, or may be learned by practice of the presented embodiments of the disclosure.

According to a first aspect of the present disclosure, a method of processing signal operation information of an intersection includes transmitting, to an external device, a driving status information message regarding a vehicle, determining a particular intersection, based on a current location and heading of the vehicle included in the driving status information message, and receiving, from the external device, a signal operation information message regarding the particular intersection, by using a geofencing area.

According to a second aspect of the present disclosure, a device for processing signal operation information of an intersection includes a communication module configured to communicate with an external device, a memory storing at least one program, and a processor configured to executing the at least one program to perform an operation, wherein the processor is further configured to control the communication module to transmit, to an external device, a driving status information message regarding a vehicle, determine a particular intersection, based on a current location and heading of the vehicle included in the driving status information message, and control the communication module to receive, from the external device, a signal operation information message regarding the particular intersection by using a geofencing area.

According to a third aspect of the present disclosure, a computer-readable recording medium may have recorded thereon a program for executing, on a computer, the method according to the first aspect.

In addition, other methods and systems for implementing the present disclosure, and a computer-readable recording medium having recorded thereon a computer program for executing the methods may be further provided.

Other aspects, features, and advantages other than those described above will be apparent from the following drawings, claims, and detailed description.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 to 3 are diagrams for describing an autonomous driving method according to an embodiment;

FIG. 4 is a diagram for describing a situation in which a vehicle and a control server communicate with each other in a vehicle-to-everything (V2X) system according to an embodiment;

FIG. 5 is an exemplary diagram for describing intersection information received from a control server according to the location and heading of a vehicle, according to an embodiment;

FIG. 6 is an exemplary diagram for describing a method of determining a particular intersection, based on the current location and heading of a vehicle, according to an embodiment;

FIGS. 7A and 7B are exemplary diagrams for describing a method of determining a particular intersection by setting a geofencing area, according to an embodiment;

FIG. 8 is a flowchart of a method of determining a method of processing signal operation information of an intersection, according to an embodiment; and

FIG. 9 is a block diagram of a V2X device for processing signal operation information of an intersection according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Advantages and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used herein are for describing particular embodiments and are not intended to limit the scope of the present disclosure. A singular expression may include a plural expression unless they are definitely different in a context. As used herein, terms such as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as “mechanism”, “element”, “unit”, or “component” are used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

Hereinafter, the term ‘vehicle’ may refer to all types of transportation instruments with engines that are used to move passengers or goods, such as cars, buses, motorcycles, kick scooters, or trucks.

Hereinafter, the present disclosure will be described in detail with reference to the accompanying drawings.

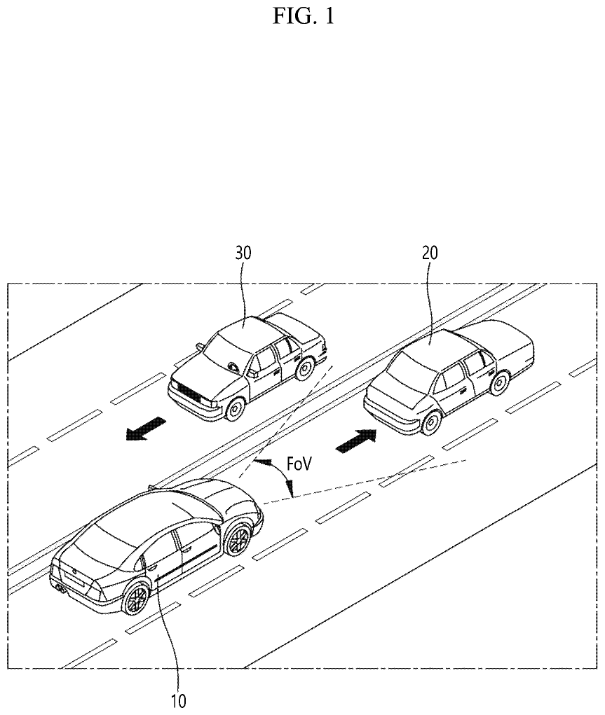

FIGS. 1 to 3 are diagrams for describing an autonomous driving method according to an embodiment.

Referring to FIG. 1, an autonomous driving apparatus according to an embodiment of the present disclosure may be mounted on a vehicle to implement an autonomous vehicle 10. The autonomous driving apparatus mounted on the autonomous vehicle 10 may include various sensors configured to collect situational information around the autonomous vehicle 10. For example, the autonomous driving apparatus may detect a movement of a preceding vehicle 20 traveling in front of the autonomous vehicle 10, through an image sensor and/or an event sensor mounted on the front side of the autonomous vehicle 10. The autonomous driving apparatus may further include sensors configured to detect, in addition to the preceding vehicle 20 traveling in front of the autonomous vehicle 10, another traveling vehicle 30 traveling in an adjacent lane, and pedestrians around the autonomous vehicle 10.

At least one of the sensors configured to collect the situational information around the autonomous vehicle may have a certain field of view (FoV) as illustrated in FIG. 1. For example, in a case in which a sensor mounted on the front side of the autonomous vehicle 10 has a FoV as illustrated in FIG. 1, information detected from the center of the sensor may have a relatively high importance. This may be because most of information corresponding to the movement of the preceding vehicle 20 is included in the information detected from the center of the sensor.

The autonomous driving apparatus may control the movement of the autonomous vehicle 10 by processing information collected by the sensors of the autonomous vehicle 10 in real time, while storing, in a memory device, at least part of the information collected by the sensors.

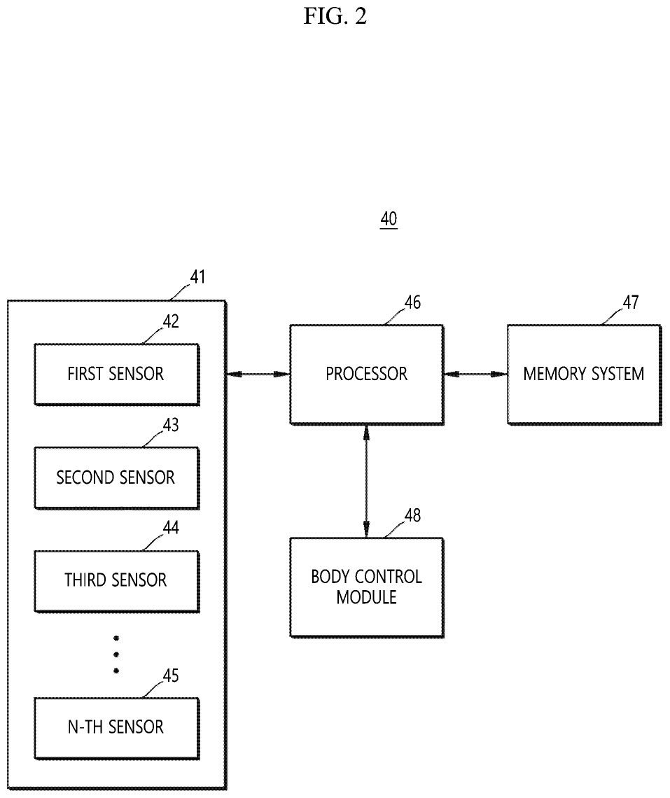

Referring to FIG. 2, an autonomous driving apparatus 40 may include a sensor unit 41, a processor 46, a memory system 47, a body control module 48, and the like. The sensor unit 41 may include a plurality of sensors 42 to 45, and the plurality of sensors 42 to 45 may include an image sensor, an event sensor, an illuminance sensor, a global positioning system (GPS) device, an acceleration sensor, and the like.

Data collected by the sensors 42 to 45 may be delivered to the processor 46. The processor 46 may store, in the memory system 47, the data collected by the sensors 42 to 45, and control the body control module 48 based on the data collected by the sensors 42 to 45 to determine the movement of the vehicle. The memory system 47 may include two or more memory devices and a system controller configured to control the memory devices. Each of the memory devices may be provided as a single semiconductor chip.

In addition to the system controller of the memory system 47, each of the memory devices included in the memory system 47 may include a memory controller, which may include an artificial intelligence (AI) computation circuit such as a neural network. The memory controller may generate computational data by applying certain weights to data received from the sensors 42 to 45 or the processor 46, and store the computational data in a memory chip.

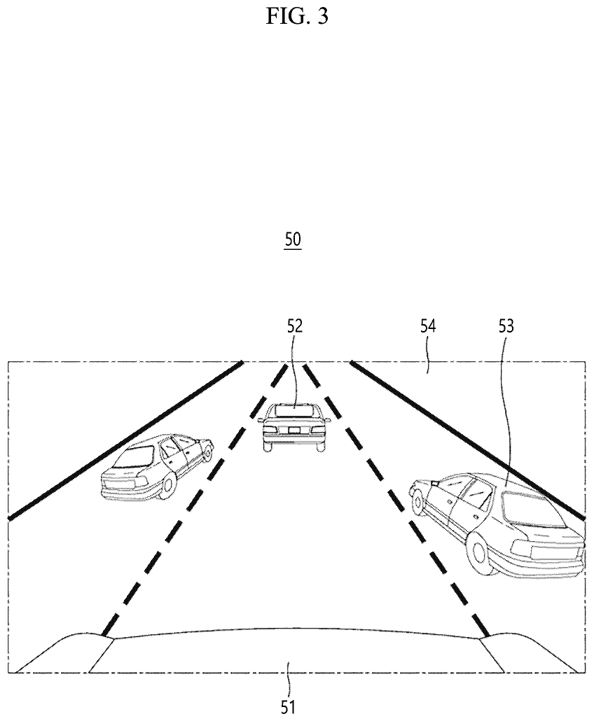

FIG. 3 is a diagram illustrating an example of image data obtained by a sensor of an autonomous vehicle on which an autonomous driving apparatus is mounted. Referring to FIG. 3, image data 50 may be data obtained by a sensor mounted on the front side of the autonomous vehicle. Thus, the image data 50 may include a front area 51 of the autonomous vehicle, a preceding vehicle 52 traveling in the same lane as the autonomous vehicle, a traveling vehicle 53 around the autonomous vehicle, a background 54, and the like.

In the image data 50 according to the embodiment illustrated in FIG. 3, data regarding a region including the front area 51 of the autonomous vehicle and the background 54 may be unlikely to affect the driving of the autonomous vehicle. In other words, the front area 51 of the autonomous vehicle and the background 54 may be regarded as data having a relatively low importance.

On the other hand, the distance to the preceding vehicle 52 and a movement of the traveling vehicle 53 to change lanes or the like may be significantly important factors in terms of safe driving of the autonomous vehicle. Accordingly, data regarding a region including the preceding vehicle 52 and the traveling vehicle 53 in the image data 50 may have a relatively high importance in terms of the driving of the autonomous vehicle.

A memory device of the autonomous driving apparatus may apply different weights to different regions of the image data 50 received from a sensor, and then store the image data 50. For example, a high weight may be applied to the data regarding the region including the preceding vehicle 52 and the traveling vehicle 53, and a low weight may be applied to the data regarding the region including the front area 51 of the autonomous vehicle and the background 54.

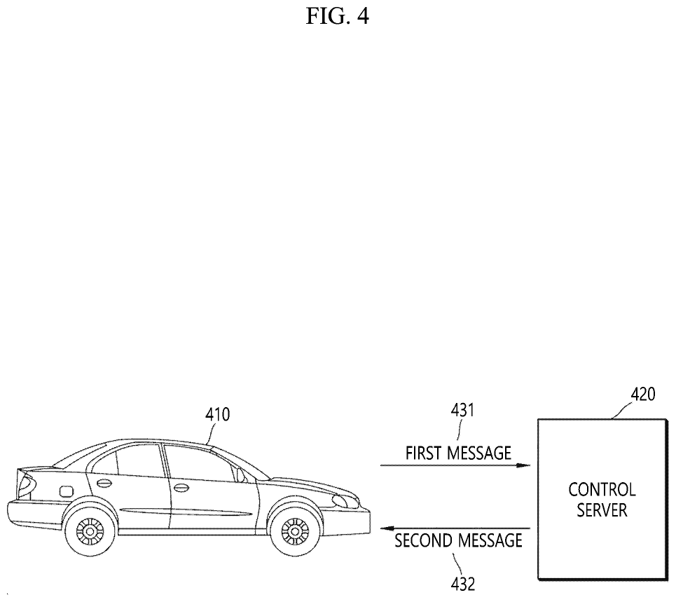

FIG. 4 is a diagram for describing a situation in which a vehicle and a control server communicate with each other in a vehicle-to-everything (V2X) system according to an embodiment.

Referring to FIG. 4, a vehicle 410 is an autonomous vehicle capable of V2X communication and may communicate with a control server 420. The control server 420 is a server operated by a control center, and the control center may manage road information, traffic information, signal information, and the like.

The vehicle 410 may transmit a first message 431 to the control server 420. In an embodiment, the first message 431 may be a driving status information message regarding the vehicle 410. The driving status information message may also be referred to as probe vehicle data (PVD). The driving status information message may include at least one of time information, location information (e.g., latitude, longitude, and elevation), speed information, and heading information of the vehicle 410. Information that may be included in the driving status information message is listed in Table 1, but is not limited thereto.

TABLE 1

| Probe Vehicle Data | | | Description | Remarks |
|---|---|---|---|---|
| probeID | name | | Device name, Version | CITSOBE-0001 |
| | temporary id | | Device temporary ID | |
| startVector | utcTime | | Datetime | UTC time upon |
| | | | (YYYYMMDDHHMMSS) | transmission |
| | long | | Longitude | Current longitude |
| | lat | | Latitude | Current latitude |
| | elevation | | Elevation | Current elevation |
| | heading | | Direction | Current direction |
| | speed | transmission | Transmission | Current transmission |

| | | status |
|---|---|---|
| speed | Speed | Current speed |

| | | posAccuracy | GPS accuracy | Current GPS accuracy |
|---|---|---|---|---|
| vehicleType | | vehicleType | Vehicle type | |
| | | vehicleClass | Vehicle class | |
| snapshots | thePosition | utcTime | Datetime | UTC time upon |
| (List) | | | (YYYYMMDDHHMMSS) | collection |

| long | | Longitude | Longitude upon |
|---|---|---|---|
| | | | collection |
| lat | | Latitude | Latitude upon |
| | | | collection |
| elevation | | Elevation | Elevation upon |
| | | | collection |
| heading | | Direction | Direction upon |
| | | | collection |
| speed | transmission | Transmission | Transmission status |

| | | upon collection |
|---|---|---|
| speed | Speed | Speed upon |

| | | | collection |
|---|---|---|---|
| | posAccuracy | GPS accuracy | GPS accuracy |
| | | | upon collection |
| safetyExt | events | Vehicle events | HazardLights |

StopLine Violation
ABSactiveated
TractionControlLoss
Stability Control
Activated
Hazardous Materials
(# replacing sudden
deceleration)
Reserved1 (# U-turn)
HardBraking
LightsChanged
WipersChanged

The control server 420 may transmit a second message 432 to the vehicle 410. The control server 420 may transmit the second message 432 to the vehicle 410 in response to the first message 431 received from the vehicle 410. In an embodiment, the second message 432 may be a signal operation information message. The signal operation information message may be referred to as signal phase and timing (SPaT). The signal operation information message may provide status information about all lanes of an intersection. The signal operation information message may include at least one of intersection name information, signal type information, pedestrian signal information, and remaining signal time information. In addition, the signal operation information message may include information about all traffic lights of intersections to be encountered by the current vehicle without making a U-turn in the current driving route.

Information that may be included in the signal operation information message is listed in Table 2, but is not limited thereto. For example, the signal operation information message may include various types of information including lane priority information and signal information about vehicles approaching from each lane of an intersection.

TABLE 2

| Signal Phase and Timing | | | | | Description | Remarks |
|---|---|---|---|---|---|---|
| intersection | name | | | | Intersection region name | |
| state | id | region | | | Intersection region ID | |
| (List) | | id | | | Intersection entry | |
| | | | | | direction ID | |
| | msgCnt | | | | Sequence number | |
| | status | | | | Signal controller status | manualControllsEnabled |
| | | | | | | stopTimeIsActivated |
| | | | | | | failureFlash |
| | | | | | | preemptIsActive |
| | | | | | | signalPriorityIsActive |
| | | | | | | fixedTimeOperation |
| | | | | | | trafficDependentOperation |
| | | | | | | standbyOperation |
| | | | | | | failureMode |
| | | | | | | off |
| | | | | | | recentMAPmessageUpdate |
| | | | | | | recentChangeInMAPassignedLanes |
| | | | | | | IDsUsed |
| | | | | | | noValidMAPisAvailableAtThisTime |
| | | | | | | noValidSPATisAvailableAtThisTime |
| | Movement | name | | | Signal type name | STR, LEFT, PED, BYC, BUS, . . . |
| | State | signal group id | | | Signal type ID | |
| | (List) | Movement | event state | | Signal state | unavailable |
| | | Event | | | | dark |
| | | | | | | stop-Then-Proceed (Reds) |
| | | | | | | stop-And-Remain (Reds) |
| | | | | | | pre-Movement (Greens) |
| | | | | | | permissive-Movement-Allowed |
| | | | | | | (Greens) |
| | | | | | | protected-Movement-Allowed |
| | | | | | | (Greens) |
| | | | | | | permissive-clearance |
| | | | | | | (Yellows/Ambers) |
| | | | | | | protected-clearance |
| | | | | | | (Yellows/Ambers) |
| | | | | | | caution-Conflicting-Traffic |
| | | | | | | (Yellows/Ambers) |
| | | | timing | min | Remaining time of signal | |
| | | | | End | | |
| | | | | Time | | |

| | | |
|---|---|---|
| Maneuver | pedbicycle detect | Whether pedestrian is |
| Assist | | detected |

Meanwhile, the vehicle 410 may transmit the first message 431 to the control server 420 at a first interval. For example, the first interval may be 1 sec, 0.1 sec, or the like. In addition, the control server 420 may transmit the second message 432 to the vehicle 410 at a second interval in response to reception of the first message 431 from the vehicle 410. The second interval may be 0.2 sec, 0.02 sec, or the like.

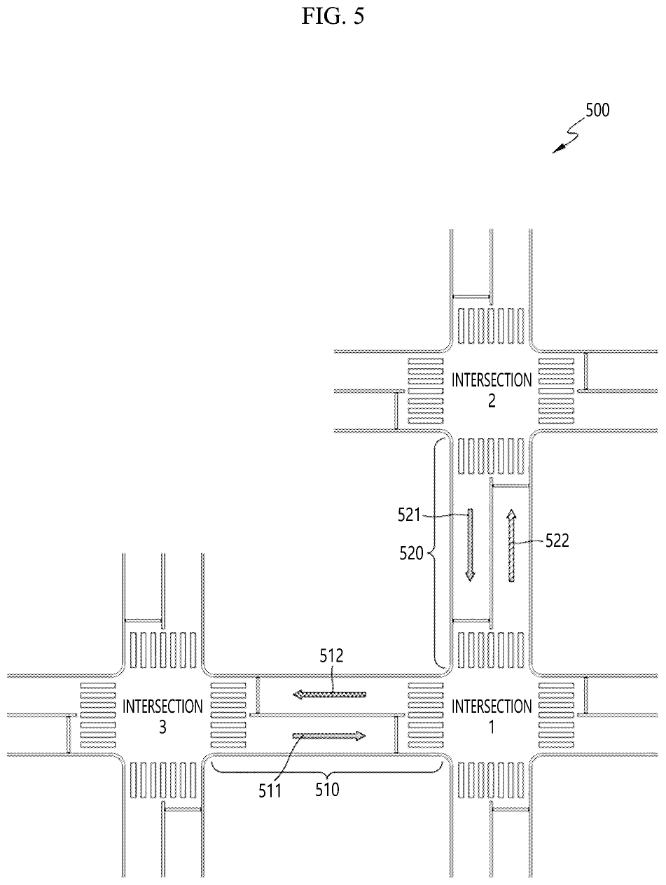

FIG. 5 is an exemplary diagram for describing intersection information received from a control server according to the location and heading of a vehicle, according to an embodiment.

FIG. 5 illustrates a road map 500 showing intersections and roads connected to the intersections. The road map 500 includes intersection 1, intersection 2, and intersection 3.

Depending on the heading of the vehicle on each of roads 510 and 520, the intersection information received by the vehicle from the control server may vary.

For example, the first road 510 includes a 1-1st road 511 and a 1-2nd road 512, the heading of the vehicle on the 1-1st road 511 is the direction toward intersection 1, and the heading of the vehicle on the 1-2nd road 512 is the direction toward intersection 3. That is, the vehicle traveling on the 1-1st road 511 may receive, from the control server, information about intersection 1, and the vehicle traveling on the 1-2nd road 512 may receive, from the control server, information about intersection 3.

In addition, the second road 520 includes a 2-1st road 521 and a 2-2nd road 522, the heading of the vehicle on the 2-1st road 521 is the direction toward intersection 1, and the heading of the vehicle on the 2-2nd road 522 is the direction toward intersection 2. That is, the vehicle traveling on the 2-1st road 521 may receive, from the control server, information about intersection 1, and the vehicle traveling on the 2-2nd road 522 may receive, from the control server, information about intersection 2.

Meanwhile, the intersection information may be a signal operation information message regarding an intersection. The signal operation information message may be referred to as SPaT. The signal operation information message may provide status information about all lanes of an intersection. The signal operation information message may include at least one of intersection name information, signal type information, pedestrian signal information, and remaining signal time information. For example, assuming that a left turn is available on all of the roads each including four lanes, and there is a pedestrian traffic light when turning right, the vehicle may receive information (e.g., the current status and remaining time to transition to the next status) about 4 3=12 traffic lights.

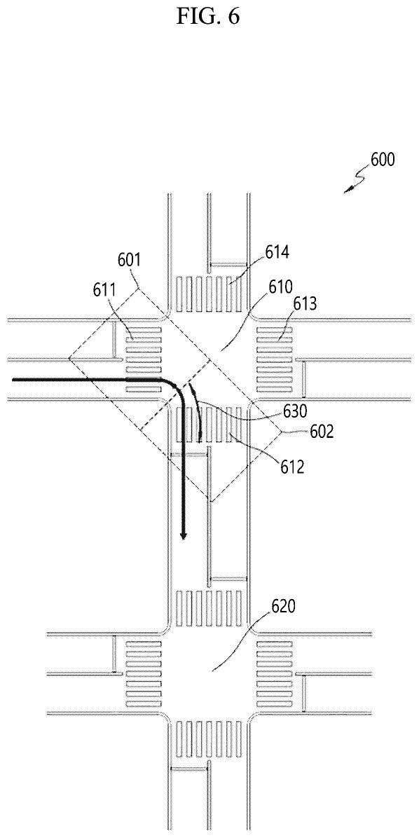

FIG. 6 is an exemplary diagram for describing a method of determining a particular intersection, based on the current location and heading of a vehicle, according to an embodiment.

FIG. 6 illustrates a road map 600 including a first intersection 610 and a second intersection 620. In addition, the road map 600 shows a route in which a vehicle enters the first intersection 610 from the left side thereof, then exits the first intersection 610 toward the lower side thereof, and travels toward the second intersection 620.

A V2X device mounted on the vehicle may receive, from a control server, a signal operation information message regarding a particular intersection, based on the location and heading of the vehicle traveling along the route. The V2X device may control the autonomous driving of the vehicle by using the signal operation information message regarding the particular intersection received from the control server.

In an embodiment, the V2X device may determine, as the particular intersection, an intersection corresponding to the road closest to the current location of the vehicle, considering the heading of the vehicle, and receive, from the control server, a signal operation information message regarding the determined particular intersection.

Referring to FIG. 6, when the heading of the vehicle is toward the first intersection 610 and the current location of the vehicle is within a first area 601, the V2X device may determine that the intersection corresponding to the road closest to the current location of the vehicle is the first intersection 610. The V2X device may receive, from the control server, a signal operation information message regarding the first intersection 610. That is, when the current location of the vehicle is within the first area 601, the V2X device may control autonomous driving of the vehicle by using the signal operation information message regarding the first intersection 610.

In addition, when the heading of the vehicle is toward the second intersection 620 and the current location of the vehicle is within a second area 602, the V2X device may determine that the intersection corresponding to the road closest to the current location of the vehicle is the second intersection 620. The V2X device may receive, from the control server, a signal operation information message regarding the second intersection 620. That is, when the current location of the vehicle is within the second area 602, the V2X device may control autonomous driving of the vehicle by using the signal operation information message regarding the second intersection 620.

A signal operation information message regarding an intersection may include pedestrian signal information. Referring to FIG. 6, the first intersection 610 includes a total of four pedestrian signals, i.e., first to fourth pedestrian signals 611, 612, 613, and 614, and pedestrian signal information about the first to fourth pedestrian signals 611, 612, 613, and 614 is included in the signal operation information message regarding the first intersection 610 rather than the second intersection 620.

Meanwhile, when the vehicle passes through the first area 601 and then travels through a particular section 630 in the second area 602, the V2X device receives, in the particular section 630, a signal operation information message regarding the second intersection 620 rather than the first intersection 610, even though the pedestrian signal information about the second pedestrian signal 612 is included in the signal operation information message regarding the first intersection 610. Accordingly, a problem may arise that the V2X device controls the autonomous driving of the vehicle to pass through the particular section 630 without considering the second pedestrian signal 612.

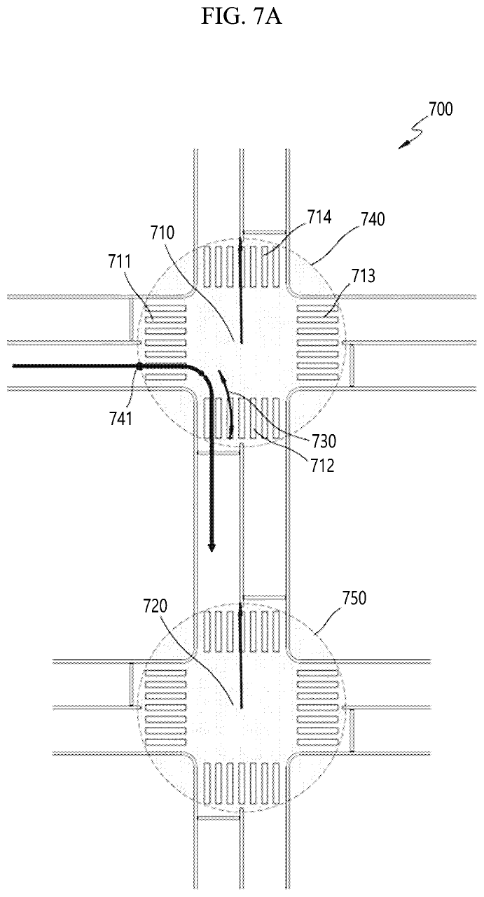

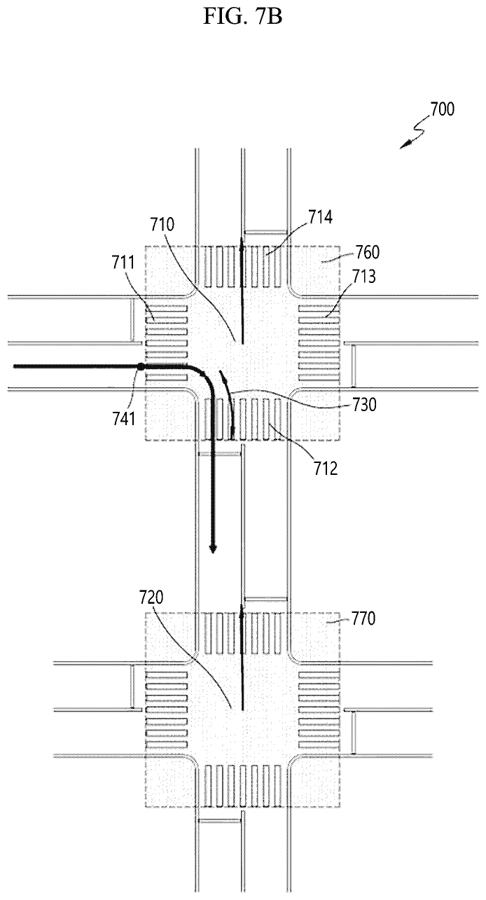

FIGS. 7A and 7B are exemplary diagrams for describing a method of determining a particular intersection by setting a geofencing area, according to an embodiment.

A geofencing area refers to a virtual boundary or area that is set based on an actual location. By setting a geofencing area around an intersection, it is possible to check whether a vehicle enters or passes through the geofencing area.

FIG. 7A illustrates a road map 700 including a first intersection 710 and a second intersection 720. In addition, the road map 700 shows a route in which a vehicle enters the first intersection 710 from the left side thereof, then exits the first intersection 710 toward the lower side thereof, and travels toward the second intersection 720.

A V2X device may set geofencing areas 740 and 750 for the plurality of intersections 710 and 720, respectively. Alternatively, the V2X device may receive, from a control server, information about the geofencing areas 740 and 750 for the plurality of intersections 710 and 720.

In an embodiment, referring to FIG. 7A, areas having a certain radius with respect to the centers of the plurality of intersections 710 and 720 may be set as the geofencing areas 740 and 750 for the plurality of intersections 710 and 720, respectively.

In another embodiment, a geofencing area having an arbitrary polygonal shape may be set around each of the plurality of intersections 710 and 720. The vertices of the polygonal geofencing area may be set to be located at points spaced apart by a preset distance from the center of each of the plurality of intersections 710 and 720. The geofencing area may be set to have a polygonal shape such as a quadrangle or an octagon.

In another embodiment, referring to FIG. 7B, polygonal geofencing areas 760 and 770, the boundaries of which are based on stop lines included in the plurality of intersections 710 and 720, respectively, may be set. The geofencing areas 760 and 770 may be set to have a polygonal shape such as a quadrangle or an octagon. The V2X device may receive location information and width information of each of a plurality of stop lines on the road map 700. Based on the receive location information and the width information, the V2X device may set the polygonal geofencing areas 760 and 770, the boundaries of which are based on the stop lines. Alternatively, the V2X device may receive, from the control server, information about the polygonal geofencing areas 760 and 770, the boundaries of which are based on the stop lines included in the plurality of intersections 710 and 720, respectively.

The V2X device may determine a particular geofencing area corresponding to the current location and heading of the vehicle. Referring to FIG. 7A, when the heading of the vehicle is toward the first intersection 710 and the current location of the vehicle is within the first geofencing area 740, the V2X device may determine that the geofencing area corresponding to the current location of the vehicle is the first geofencing area 740.

The V2X device may determine the particular intersection, based on whether the vehicle has passed through the particular geofencing area. In detail, while the vehicle is passing through the particular geofencing area, the V2X device may fix the current location of the vehicle to a location at which a signal operation information message regarding the particular intersection may be received. For example, the V2X device may fix the current location of the vehicle to an entry point of the particular geofencing area. Also, the V2X device may determine, as the particular intersection, an intersection closest to the fixed location of the vehicle among a plurality of intersections. In addition, after the vehicle passes through the particular geofencing area, the V2X device may determine, as the particular intersection, an intersection corresponding to the road closest to the current location of the vehicle among the plurality of intersections.

Referring to FIG. 7A, the V2X device may fix the current location of the vehicle to the location of an entry point 741 of the first geofencing area 740, while the vehicle is passing through the first geofencing area 740. However, the fixed location is not limited to the entry point 741, and may be the location of an arbitrary point within the first area 601 in FIG. 6. The V2X device may fix the current location of the vehicle to the location of an entry point 741 of the first geofencing area 740, until the vehicle has passed through the first geofencing area 740.

In an embodiment, the V2X device may dynamically adjust the size of the geofencing area, based on traffic information around the intersection. For example, when the traffic around the intersection is smooth, the V2X device may set the size of the geofencing area to be greater than a reference value. Whether the traffic is smooth may be determined based on the average speed of vehicles passing around the intersection. When the average speed of the vehicles is greater than a threshold value, the V2X device may set the size of the geofencing area to be larger in proportion to the average speed of the vehicles. Accordingly, according to the present disclosure, even when the driving speed of the vehicle is greater than the threshold value, the current location of the vehicle may be stably fixed to the location of an arbitrary point (e.g., the entry point) in the geofencing area.

Meanwhile, a particular section 730 of FIGS. 7A and 7B corresponds to the particular section 630 of FIG. 6, and according to the method of determining a particular intersection described above with reference to FIG. 6, when the vehicle is located in the particular section 730 of FIGS. 7A and 7B, the V2X device receives a signal operation information message regarding the second intersection 720 rather than the first intersection 710.

On the other hand, according to the method of determining a particular intersection described above with reference to FIGS. 7A and 7B, even when the vehicle is located in the particular section 730 of FIGS. 7A and 7B, as the current location of the vehicle is fixed to the entry point 741 of the first geofencing area 740, the V2X device may receive a signal operation information message regarding the first intersection 710. Accordingly, even when the vehicle drives in the particular section 730, the V2X device may receive the signal operation information message regarding the first intersection 710, and thus control autonomous driving of the vehicle such that the vehicle passes through the particular section 730 considering a second pedestrian signal 712.

After the vehicle passes through the first geofencing area 740, the V2X device may no longer fix the current location of the vehicle to the entry point 741 of the first geofencing area 740, and determine the particular intersection based on the actual current location and heading of the vehicle. In detail, the V2X device may determine, as the particular intersection, the second intersection 720, which corresponds to the road closest to the current location of the vehicle, among the plurality of intersections, considering the heading of the vehicle.

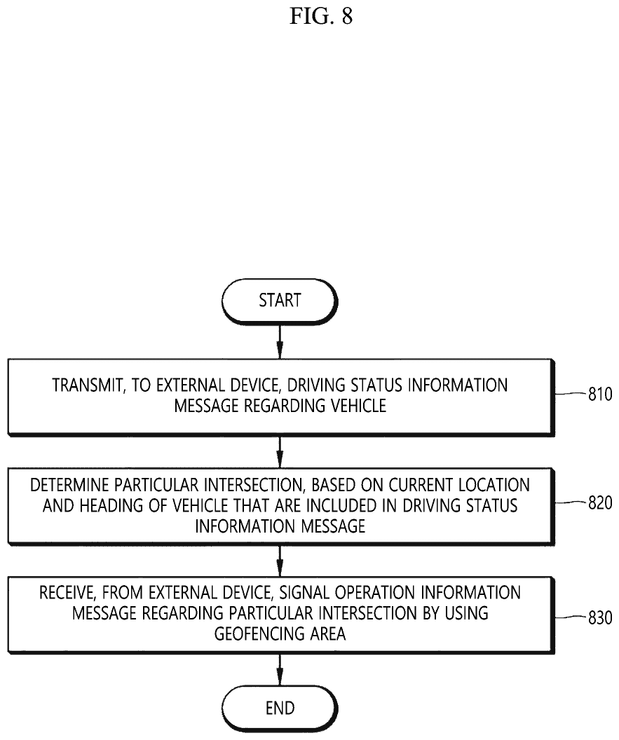

FIG. 8 is a flowchart of a method of processing signal operation information of an intersection, according to an embodiment.

The method of processing signal operation information illustrated in FIG. 8 is related to the embodiments described above with reference to the drawings, and thus, the descriptions provided above but omitted below may also be applied to the method illustrated in FIG. 8.

Referring to FIG. 8, in operation 810, a processor may transmit, to an external device, a driving status information message regarding a vehicle.

The external device may be a control server. The control server is a server operated by a control center, and the control center may manage road information, traffic information, signal information, and the like.

The driving status information message may also be referred to as PVD. The driving status information message may include at least one of time information, location information (e.g., latitude, longitude, and elevation), speed information, and heading information of the vehicle. Information that may be included in the driving status information message is listed in Table 1, but is not limited thereto.

In operation 820, the processor may determine a particular intersection, based on the current location and heading of the vehicle that are included in the driving status information message.

The processor may set geofencing areas for a plurality of intersections, respectively. The processor may determine a particular geofencing area corresponding to the current location and heading of the vehicle. The processor may determine the particular intersection, based on whether the vehicle has passed through the particular geofencing area.

While the vehicle is passing through the particular geofencing area, the processor may fix the current location of the vehicle to a location at which a signal operation information message regarding the particular intersection may be received. The processor may determine, as the particular intersection, an intersection closest to the fixed location of the vehicle among the plurality of intersections.

The processor may fix the current location of the vehicle to an entry point of the particular geofencing area.

After the vehicle passes through the particular geofencing area, the processor may determine, as the particular intersection, an intersection corresponding to the road closest to the current location of the vehicle among the plurality of intersections.

In an embodiment, the processor may set an area having a certain radius with respect to the center of each of the plurality of intersections, as the geofencing area for each of the plurality of intersections.

In another embodiment, the processor may set a geofencing area for each of the plurality of intersections to have a boundary based on a stop line included in the intersection.

In operation 830, the processor may receive, from the external device, a signal operation information message regarding the particular intersection by using the geofencing area.

The signal operation information message may be referred to as SPaT. The signal operation information message may provide status information about all lanes of an intersection. The signal operation information message may include at least one of intersection name information, signal type information, pedestrian signal information, and remaining signal time information. In addition, the signal operation information message may include information about all traffic lights of intersections to be encountered by the current vehicle without making a U-turn in the current driving route.

Information that may be included in the signal operation information message is listed in Table 2, but is not limited thereto. For example, the signal operation information message may include various types of information including lane priority information and signal information about vehicles approaching from each lane of an intersection.

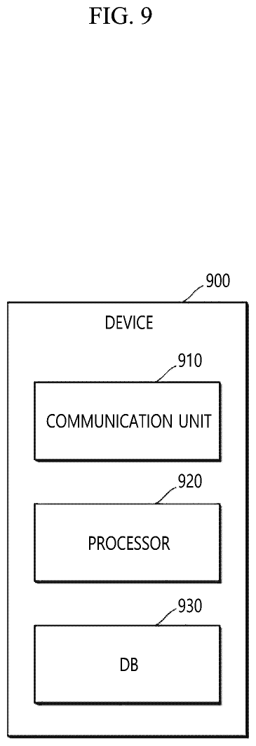

FIG. 9 is a block diagram of a V2X device for processing signal operation information of an intersection according to an embodiment.

Referring to FIG. 9, a V2X device 900 for processing signal operation information of an intersection may include a communication unit 910, a processor 920, and a database (DB) 930. FIG. 9 illustrates the V2X device 900 including only the components related to an embodiment. Therefore, it would be understood by those of skill in the art that other general-purpose components may be further included in addition to those illustrated in FIG. 9.

The communication unit 910 may include one or more components for performing wired/wireless communication with an external server or an external device. For example, the communication unit 910 may include at least one of a short-range communication unit (not shown), a mobile communication unit (not shown), and a broadcast receiver (not shown).

The communication unit 910 may transmit a driving status information message to an external device, and receive, from the external device, a signal operation information message regarding a particular intersection.

The DB 930 is hardware for storing various pieces of data processed by the V2X device 900, and may store a program for the processor 920 to perform processing and control. The DB 930 may store payment information, user information, and the like.

The DB 930 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 920 controls the overall operation of the V2X device 900. For example, the processor 920 may execute programs stored in the DB 930 to control the overall operation of an input unit (not shown), a display (not shown), the communication unit 910, the DB 930, and the like. The processor 920 may execute programs stored in the DB 930 to control the operation of the V2X device 900.

The processor 920 may control at least some of the operations of the V2X device described above with reference to FIGS. 1 to 8.

In addition, the processor 920 may receive the signal operation information message regarding the particular intersection by using the method described above with reference to FIGS. 1 to 8, and control a vehicle based on the signal operation information message.

The processor 920 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the V2X device 900 may be a mobile electronic device. For example, the V2X device 900 may be implemented as a smart phone, a tablet personal computer (PC), a PC, a smart television (TV), a personal digital assistant (PDA), a laptop computer, a media player, a navigation system, a camera-equipped device, and other mobile electronic devices. In addition, the V2X device 900 may be implemented as a wearable device having a communication function and a data processing function, such as a watch, glasses, a hair band, a ring, or the like.

In another embodiment, the V2X device 900 may be an electronic device embedded in a vehicle. For example, the V2X device 900 may be an electronic device that is manufactured and then inserted into a vehicle through tuning.

As another embodiment, the V2X device 900 may be a server located outside a vehicle. The server may be implemented as a computer device or a plurality of computer devices that provide a command, code, a file, content, a service, and the like by performing communication through a network. The server may receive data necessary for determining a moving path of the vehicle from devices mounted on the vehicle, and determine the moving path of the vehicle based on the received data.

In another embodiment, a process performed by the V2X device 900 may be performed by at least some of a mobile electronic device, an electronic device embedded in the vehicle, and a server located outside the vehicle.

Embodiments of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

Meanwhile, the computer program may be specially designed and configured for the present disclosure or may be well-known to and usable by those skill in the art of computer software. Examples of the computer program may include not only machine code, such as code made by a compiler, but also high-level language code that is executable by a computer by using an interpreter or the like.

According to an embodiment, the method according to various embodiments disclosed herein may be included in a computer program product and provided. The computer program products may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

The operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. In addition, various modifications, combinations, and adaptations will be readily apparent to those skill in the art without departing from the following claims and equivalents thereof.

Accordingly, the spirit of the present disclosure should not be limited to the above-described embodiments, and all modifications and variations which may be derived from the meanings, scopes and equivalents of the claims should be construed as failing within the scope of the present disclosure.

According to the above-mentioned aspects of the present disclosure, autonomous driving of a vehicle may be prevented from being controlled according to signal operation information about an intersection that has a low correlation with the section in which the vehicle is currently driving.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of processing signal operation information of an intersection, the method comprising:
transmitting, to an external device, a driving status information message regarding a vehicle;
determining a particular intersection, based on a current location and heading of the vehicle included in the driving status information message; and
receiving, from the external device, a signal operation information message regarding the particular intersection, by using a geofencing area.

2. The method of claim 1, wherein the determining of the particular intersection comprises:
setting geofencing areas for a plurality of intersections, respectively;
determining a particular geofencing area corresponding to the current location and heading of the vehicle; and
determining the particular intersection, based on whether the vehicle has passed through the particular geofencing area.

3. The method of claim 2, wherein the determining of the particular intersection further comprises:
while the vehicle is passing through the particular geofencing area, fixing the current location of the vehicle to a location at which the vehicle is able to receive the signal operation information message regarding the particular intersection; and
determining, as the particular intersection, an intersection closest to the fixed location, from among the plurality of intersections.

4. The method of claim 3, wherein the fixing comprises fixing the current location of the vehicle to an entry point of the particular geofencing area.

5. The method of claim 3, wherein the determining of the particular intersection further comprises, after the vehicle passes through the particular geofencing area, determining, as the particular intersection, an intersection corresponding to a road closest to the current location of the vehicle, from among the plurality of intersections.

6. The method of claim 2, wherein the setting of the geofencing areas comprises setting areas having a certain radius with respect to centers of the plurality of intersections, as the geofencing areas for the plurality of intersections, respectively.

7. The method of claim 2, wherein the setting of the geofencing areas comprises setting the geofencing areas for the plurality of intersections to have boundaries based on stop lines included in the plurality of intersections, respectively.

8. The method of claim 1, wherein the driving status information message comprises at least one of location information, speed information, and heading information of the vehicle.

9. The method of claim 1, wherein the signal operation information message comprises at least one of intersection name information, signal type information, pedestrian signal information, and remaining signal time information.

10. The method of claim 1, further comprising controlling the vehicle based on the signal operation information message.

11. A device for processing signal operation information of an intersection, the device comprising:
a communication module configured to communicate with an external device;
a memory storing at least one program; and
a processor configured to executing the at least one program to perform an operation,
wherein the processor is further configured to control the communication module to transmit, to an external device, a driving status information message regarding a vehicle, determine a particular intersection, based on a current location and heading of the vehicle included in the driving status information message, and control the communication module to receive, from the external device, a signal operation information message regarding the particular intersection by using a geofencing area.

12. A computer-readable recording medium having recorded thereon a program for executing, on a computer, the method of claim 1.
